(19) United States
(12) Patent Application Publication
(10) Pub. No.: US 2026/0064573 A1
(43) Pub. Date: Mar. 5, 2026

(54) SYSTEMS AND METHODS FOR COMMON FRAMEWORK PROCESSING OF DIFFERENT SOFTWARE APPLICATIONS

(71) Applicant: Truist Bank, Charlotte, NC (US)

(72) Inventors: Logendran Kannuthurai, Charlotte, NC (US); Sabu Kunneth, Charlotte, NC (US); Sam Fernix Lyadurai, Charlotte, NC (US)

(73) Assignee: Truist Bank, Charlotte, NC (US)

(21) Appl. No.: 18/822,135

(22) Filed: Aug. 31, 2024

(51) Int. Cl. G06F 11/36

(52) U.S. Cl. CPC G06F 11/3688; G06F 11/3692

(57) ABSTRACT

A method, computer program product, and computer system for generating, by a computing device, a plurality of computer-based tests to be executed from a computer platform. A first computer-based test among the plurality of computer-based tests may be configured from the computer platform for execution with a first software application. A second computer-based test among the plurality of computer-based tests may be configured from the computer platform for execution with a second software application. A third computer-based test among the plurality of computer-based tests may be configured from the computer platform for execution with a third software application. A fourth computer-based test among the plurality of computer-based tests may be configured from the computer platform for execution with a fourth software application. Each of the first computer-based test, the second computer-based test, the third computer-based test, and the fourth computer-based test may be executed from the computer platform.

### TECHNICAL FIELD

The present disclosure relates to computer-based testing, and more particularly, to unifying the testing of multiple software applications on a platform.

### BACKGROUND

Testing computer-based software applications generally requires testing multiple connecting applications like User Interface (UI), Application Programming Interface (API), Mainframe and Database. In some situations, such as executing regression and End to End tests, these tests will execute typically multiple times when there are updates, enhancements, patches, or configuration changes applied to the application.

### SUMMARY

In one example implementation, a computer-implemented method, performed by one or more computing devices, may include but is not limited to generating, by a computing device, a plurality of computer-based tests to be executed from a computer platform. A first computer-based test among the plurality of computer-based tests may be configured from the computer platform for execution with a first application. A second computer-based test among the plurality of computer-based tests may be configured from the computer platform for execution with a second application. A third computer-based test among the plurality of computer-based tests may be configured from the computer platform for execution with a third application. A fourth computer-based test among the plurality of computer-based tests may be configured from the computer platform for execution with a fourth application. Each of the first computer-based test, the second computer-based test, the third computer-based test, and the fourth computer-based test may be executed from the computer platform.

One or more of the following example features may be included. The first application may be a web application, wherein the second application may be an application programming interface (API) application, and wherein the third application may be a datastore application. Configuring the first computer-based test among the plurality of computer-based tests for execution with the first application may include adding a plurality of dependencies for the first computer-based test, creating a plurality of test classes for the first computer-based test, and validating the first computer-based test based upon, at least in part, the plurality of dependencies and the plurality of test classes. Configuring the second computer-based test among the plurality of computer-based tests for execution with the second application may include adding a plurality of dependencies for the second computer-based test, generating API test cases for the second computer-based test, serializing data associated with the API test cases, deserializing the data associated with the API test cases, and validating the second computer-based test based upon, at least in part, the API test cases. Configuring the third computer-based test among the plurality of computer-based tests for execution with the third application may include initializing a webdriver for browser automation, performing simulated user interface (UI) actions on the web application, and validating UI data for the third computer-based test by comparing the UI data with results from the datastore application. The fourth application may be a mainframe application. Configuring the fourth computer-based test among the plurality of computer-based tests for execution with the fourth application may include configuring a terminal emulator to be executed with the fourth-computer-based test, and executing one or more scripts to navigate through mainframe screens, input data, and verify outputs.

In another example implementation, a computing system may include one or more processors and one or more memories configured to perform operations that may include but are not limited to generating, by a computing device, a plurality of computer-based tests to be executed from a computer platform. A first computer-based test among the plurality of computer-based tests may be configured from the computer platform for execution with a first application. A second computer-based test among the plurality of computer-based tests may be configured from the computer platform for execution with a second application. A third computer-based test among the plurality of computer-based tests may be configured from the computer platform for execution with a third application. A fourth computer-based test among the plurality of computer-based tests may be configured from the computer platform for execution with a fourth application. Each of the first computer-based test, the second computer-based test, the third computer-based test, and the fourth computer-based test may be executed from the computer platform.

One or more of the following example features may be included. The first application may be a web application, wherein the second application may be an application programming interface (API) application, and wherein the third application may be a datastore application. Configuring the first computer-based test among the plurality of computer-based tests for execution with the first application may include adding a plurality of dependencies for the first computer-based test, creating a plurality of test classes for the first computer-based test, and validating the first computer-based test based upon, at least in part, the plurality of dependencies and the plurality of test classes. Configuring the second computer-based test among the plurality of computer-based tests for execution with the second application may include adding a plurality of dependencies for the second computer-based test, generating API test cases for the second computer-based test, serializing data associated with the API test cases, deserializing the data associated with the API test cases, and validating the second computer-based test based upon, at least in part, the API test cases. Configuring the third computer-based test among the plurality of computer-based tests for execution with the third application may include initializing a webdriver for browser automation, performing simulated user interface (UI) actions on the web application, and validating UI data for the third computer-based test by comparing the UI data with results from the datastore application. The fourth application may be a mainframe application. Configuring the fourth computer-based test among the plurality of computer-based tests for execution with the fourth application may include configuring a terminal emulator to be executed with the fourth-computer-based test, and executing one or more scripts to navigate through mainframe screens, input data, and verify outputs.

In another example implementation, a computer program product may reside on a computer readable storage medium having a plurality of instructions stored thereon which, when executed across one or more processors, may cause at least a portion of the one or more processors to perform operations that may include but are not limited to generating, by a computing device, a plurality of computer-based tests to be executed from a computer platform. A first computer-based test among the plurality of computer-based tests may be configured from the computer platform for execution with a first application. A second computer-based test among the plurality of computer-based tests may be configured from the computer platform for execution with a second application. A third computer-based test among the plurality of computer-based tests may be configured from the computer platform for execution with a third application. A fourth computer-based test among the plurality of computer-based tests may be configured from the computer platform for execution with a fourth application. Each of the first computer-based test, the second computer-based test, the third computer-based test, and the fourth computer-based test may be executed from the computer platform.

One or more of the following example features may be included. The first application may be a web application, wherein the second application may be an application programming interface (API) application, and wherein the third application may be a datastore application. Configuring the first computer-based test among the plurality of computer-based tests for execution with the first application may include adding a plurality of dependencies for the first computer-based test, creating a plurality of test classes for the first computer-based test, and validating the first computer-based test based upon, at least in part, the plurality of dependencies and the plurality of test classes. Configuring the second computer-based test among the plurality of computer-based tests for execution with the second application may include adding a plurality of dependencies for the second computer-based test, generating API test cases for the second computer-based test, serializing data associated with the API test cases, deserializing the data associated with the API test cases, and validating the second computer-based test based upon, at least in part, the API test cases. Configuring the third computer-based test among the plurality of computer-based tests for execution with the third application may include initializing a webdriver for browser automation, performing simulated user interface (UI) actions on the web application, and validating UI data for the third computer-based test by comparing the UI data with results from the datastore application. The fourth application may be a mainframe application. Configuring the fourth computer-based test among the plurality of computer-based tests for execution with the fourth application may include configuring a terminal emulator to be executed with the fourth-computer-based test, and executing one or more scripts to navigate through mainframe screens, input data, and verify outputs.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### DRAWINGS

FIG. 1 is an example diagrammatic view of a testing process coupled to an example distributed computing network according to one or more example implementations of the disclosure;

FIG. 2 is an example diagrammatic view of a computing device of FIG. 1 according to one or more example implementations of the disclosure;

FIG. 3 is an example flowchart of a testing process according to one or more example implementations of the disclosure;

FIG. 4 is an example diagrammatic view of an example automation framework architecture according to one or more example implementations of the disclosure;

FIG. 5 is an example diagrammatic view of an example testing architecture according to one or more example implementations of the disclosure;

FIG. 6 is an example diagrammatic view of an example API test automation process according to one or more example implementations of the disclosure;

FIG. 7 is an example diagrammatic view of an example workflow according to one or more example implementations of the disclosure;

FIG. 8 is an example diagrammatic view of an example displayed screen according to one or more example implementations of the disclosure; and

FIG. 9 is an example diagrammatic view of an example mainframe page class according to one or more example implementations of the disclosure.

Like reference symbols in the various drawings indicate like elements.

### DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether. In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

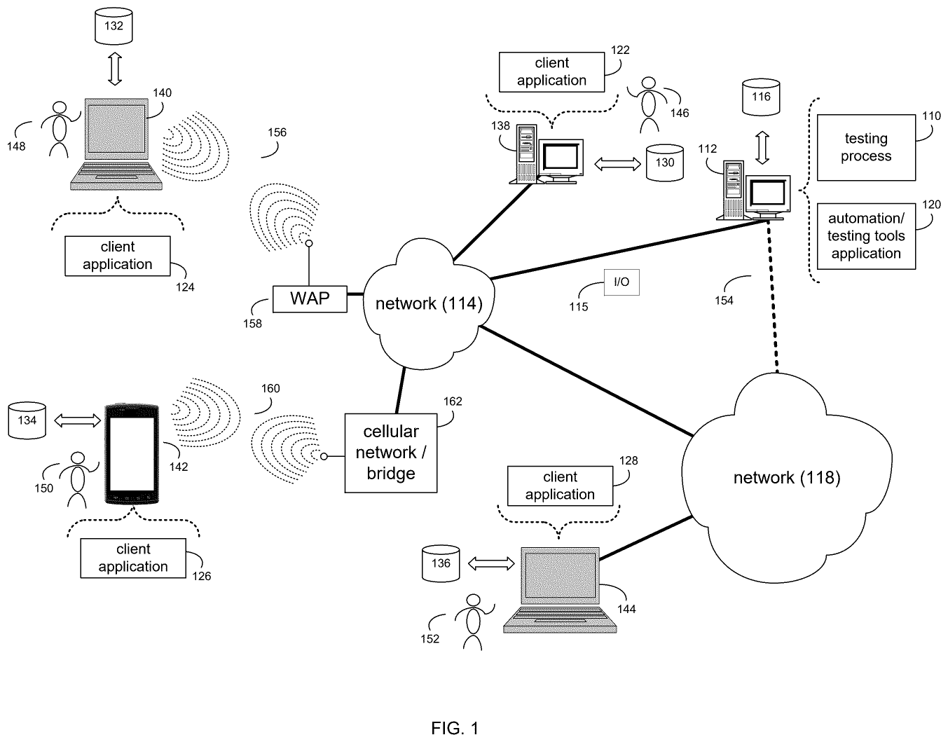

Referring now to the example implementation of FIG. 1, there is shown testing process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a testing process, such as testing process 110 of FIG. 1, may generate, by a computing device, a plurality of computer-based tests to be executed from a computer platform. A first computer-based test among the plurality of computer-based tests may be configured from the computer platform for execution with a first application. A second computer-based test among the plurality of computer-based tests may be configured from the computer platform for execution with a second application. A third computer-based test among the plurality of computer-based tests may be configured from the computer platform for execution with a third application. A fourth computer-based test among the plurality of computer-based tests may be configured from the computer platform for execution with a fourth application. Each of the first computer-based test, the second computer-based test, the third computer-based test, and the fourth computer-based test may be executed from the computer platform.

In some implementations, the instruction sets and subroutines of testing process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, testing process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a automation/testing application (e.g., automation/testing application 120), examples of which may include, but are not limited to, e.g., an automated testing application, a cross-browser testing application, a regression testing application, a continuous integration/continuous deployment (CI/CD) application, a web scraping application, a user actions simulation application, a dynamic web application testing application, a browser automation tool application, a development tools application, or other application that allows for developing and deploying similar tasks. [In some implementations, testing process 110 and/or automation/testing application 120 may be accessed via one or more of client applications 122, 124, 126, 128. In some implementations, testing process 110 may be a standalone application, or may be an applet/application/script/extension that may interact with and/or be executed within automation/testing application 120, a component of automation/testing application 120, and/or one or more of client applications 122, 124, 126, 128. In some implementations, automation/testing application 120 may be a standalone application, or may be an applet/application/script/extension that may interact with and/or be executed within testing process 110, a component of testing process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of testing process 110 and/or automation/testing application 120. Examples of client applications 122, 124, 126, 128 may include, but are not limited to, e.g., a VR application, XR or MR application, an AR application, an automated testing application, a cross-browser testing application, a regression testing application, a continuous integration/continuous deployment (CI/CD) application, a web scraping application, a user actions simulation application, a dynamic web application testing application, a browser automation tool application, a development tools application, or other application that allows for developing and deploying similar tasks, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat Linux®, Windows® Mobile, Chrome OS, Blackberry OS, Fire OS, or a custom operating system.

In some implementations, one or more of client applications 122, 124, 126, 128 may be configured to effectuate some or all of the functionality of testing process 110 (and vice versa). Accordingly, in some implementations, testing process 110 may be a purely server-side application, a purely client-side application, or a hybrid server-side/client-side application that is cooperatively executed by one or more of client applications 122, 124, 126, 128 and/or testing process 110.

In some implementations, one or more of client applications 122, 124, 126, 128 may be configured to effectuate some or all of the functionality of automation/testing application 120 (and vice versa). Accordingly, in some implementations, automation/testing application 120 may be a purely server-side application, a purely client-side application, or a hybrid server-side/client-side application that is cooperatively executed by one or more of client applications 122, 124, 126, 128 and/or automation/testing application 120. As one or more of client applications 122, 124, 126, 128, testing process 110, and automation/testing application 120, taken singly or in any combination, may effectuate some or all of the same functionality, any description of effectuating such functionality via one or more of client applications 122, 124, 126, 128, testing process 110, automation/testing application 120, or combination thereof, and any described interaction(s) between one or more of client applications 122, 124, 126, 128, testing process 110, automation/testing application 120, or combination thereof to effectuate such functionality, should be taken as an example only and not to limit the scope of the disclosure.

In some implementations, one or more of users 146, 148, 150, 152 may access computer 112 and testing process 110 (e.g., using one or more of client electronic devices 138, 140, 142, 144) directly through network 114 or through network 118. Further, computer 112 may be connected to network 114 through network 118, as illustrated with phantom link line 154. Testing process 110 may include one or more user interfaces, such as browsers and textual or graphical user interfaces, through which users 146, 148, 150, 152 may access testing process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (Saas), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

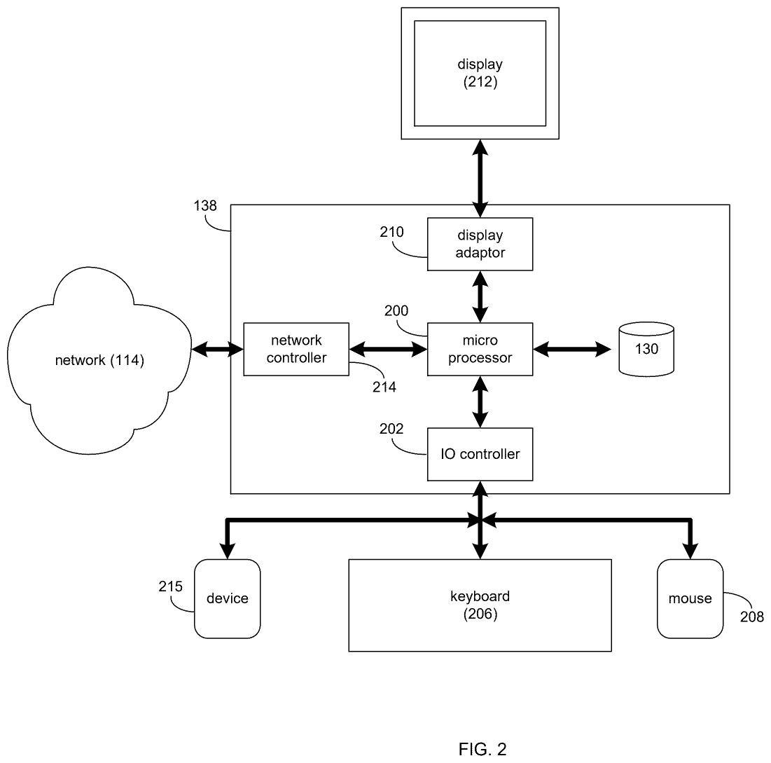

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, testing process 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

Testing computer-based applications generally requires testing multiple connecting applications like User Interface (UI), Application Programming Interface (API), Mainframe and Database. In some situations, such as executing regression and End to End tests, these tests will execute typically multiple times when there are updates, enhancements, patches, or configuration changes applied to the application. In this case, all the testers may be involved to manually execute the tests and document the results. This is very time consuming, as manual testing requires significant time and effort, especially for regression testing and testing large or complex systems. Testers must repeat the same tests manually, which can slow done the release cycle. More importantly, there is likely limited coverage. Comprehensive test coverage, especially for regression testing across various environments and configurations, becomes challenging and often incomplete. There is also the issue of complex API testing, since APIs can be complex with nested data structures and multiple endpoints. Testing all possible combinations and scenarios consumes more time and effort. Regarding another issue of mainframe data accessibility, mainframe systems typically integrate with legacy applications and databases. Testing manually requires specialized knowledge and it is difficult to do the repetitive test, which includes multiple terminals to generate the end Predictive Failure Analysis (PFA's). There is also the issue of datastore (e.g., database) dependency, as database validation is performed in various testing applications (e.g., UI, API and Mainframe). Conducting manual tests by executing and timing complex queries, batch processes, or data loading operations will be time consuming and require repetitive tasks, as well as a knowledge of the underling multiple platforms needed for accessing and testing their individual UIs, APIs, databases, and mainframes.

Therefore, as will be discussed in greater detail below, the present disclosure discusses a single platform (e.g., an automation/testing tools application platform, such as but not limited to Selenium and/or testing process 110) that can be used for UI automation/testing, extended to API automation/testing, and even mainframe and database automation/testing. Testing process 110 combined with a high-level object-oriented programming language, such as Java, may allow direct interaction with databases. Testing process 110 may use a database connectivity library (e.g., Java Database Connectivity Library or JDBC) to achieve the database integration, and may use a WebDriver API along with a terminal emulator's scripting capabilities to automate the mainframe interactions. Testing process 110 may be implemented with the high-level object-oriented programming language and a testing framework (such as Test Next Generation or TestNG) to provide a singular robust framework platform for building and executing the automated tests for web applications, APIs, mainframe and database. This provides multiple technical advantages, such as speed, efficiency, and scalability. Testing can be performed multiple times without manual interventions on a single platform, which can leverage automation scripts for Continuous Integration and Continuous Deployment (CI/CD) for continuous testing.

As will be discussed below, testing process 110 may at least help, e.g., improve computer testing across multiple applications, necessarily rooted in computer technology, in order to overcome an example and non-limiting problem specifically arising in the realm of computer testing systems and improve existing technological processes associated with, e.g., integration of multiple tests across a plurality of applications on a single platform. It will be appreciated that the computer processes described throughout are integrated into one or more practical applications, and when taken at least as a whole are not considered to be well-understood, routine, and conventional functions.

### The Testing Process

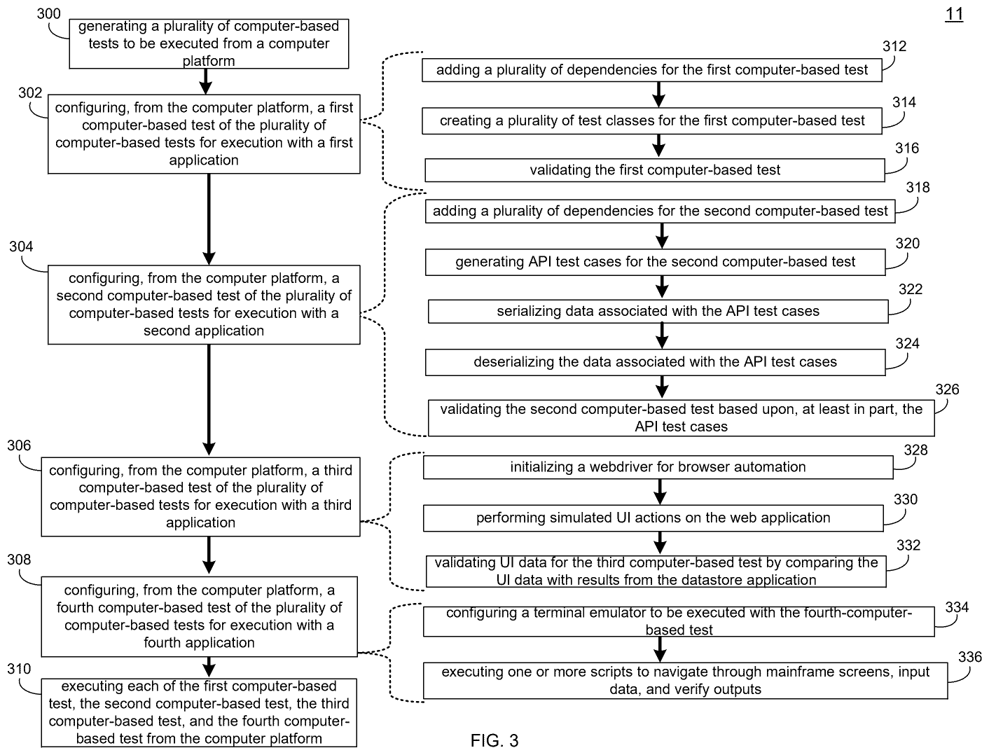

As discussed above and referring also at least to the example implementations of FIGS. 3-9, testing process 110 may generate 300, by a computing device, a plurality of computer-based tests to be executed from a computer platform. Testing process 110 may configure 302 a first computer-based test among the plurality of computer-based tests from the computer platform for execution with a first application. Testing process 110 may configure 304 a second computer-based test among the plurality of computer-based tests from the computer platform for execution with a second application. Testing process 110 may configure 306 a third computer-based test among the plurality of computer-based tests from the computer platform for execution with a third application. Testing process 110 may configure 308 a fourth computer-based test among the plurality of computer-based tests from the computer platform for execution with a fourth application. Testing process 110 may execute 310 each of the first computer-based test, the second computer-based test, the third computer-based test, and the fourth computer-based test from the computer platform.

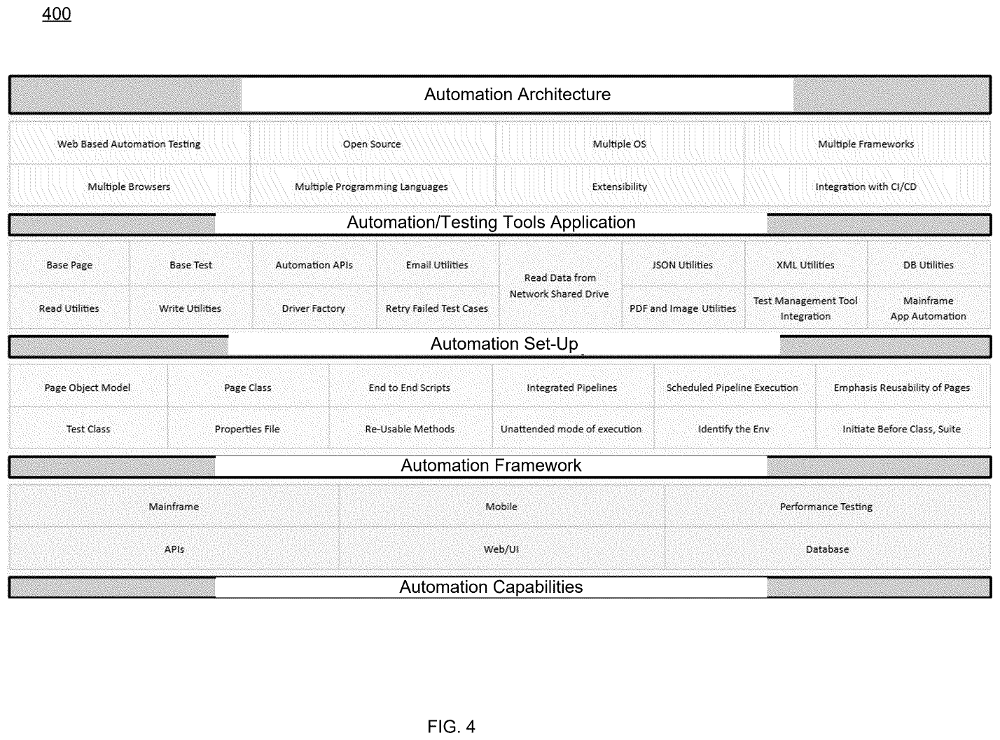

In some implementations, testing process 110 may generate 300, by a computing device, a plurality of computer-based tests to be executed from a computer platform. For instance, referring at least to the example implementation of FIG. 4, an example automation framework architecture 400 of testing process 110 for generating computer-based tests on a single platform is shown. Automation framework architecture 400 shows the automation/testing tools application portion of testing process 110 (e.g., web-based automation testing, open source, multiple OS, multiple frameworks, multiple browsers, multiple programming languages, extensibility, integration with CI/CD, etc.). Automation framework architecture 400 also shows the automation set-up portion of testing process 110 (e.g., base page, base test, automation APIs, email utilities, read data from network shared drive, JSON (or similar) utilities, XML (or similar) utilities, datastore utilities, read utilities, write utilities, driver factory, retry failed test cases, PDF and image utilities, test management tool integration, mainframe application automation, etc.). Automation framework architecture 400 also shows the automation framework portion of testing process 110 (e.g., pager object model, page class, end to end scripts, integrated pipelines, scheduled pipeline execution, emphasis reusability of pages, test class, properties file, re-usable methods, unattended mode of execution, identify the Env, initiate before class, suite, etc.). Automation framework architecture 400 also shows the automation capabilities portion of testing process 110 (e.g., mainframe, mobile, performance testing, APIs, web/UIs, datastore, etc.). As will be discussed in greater detail below, testing process 110 may use its automation framework architecture 400 for setting up project dependencies and configuring test suites and execution.

For example, testing process 110 may enable configuring test suites using an XML file. In the XML configuration file, testing process 110 may define a suite and include multiple test classes. Each class may represent a set of test methods. Testing process 110 can then run this suite using its build tool, which will execute all the tests defined in the suite. As another example, testing process 110 may provide a way to define a test suite by creating a class annotated with @Suite. In this class, testing process 110 can specify which test classes to include in the suite. When running this suite class, it will execute all the tests in the specified test classes. This can be done from an IDE, command line, or the build tool.

As another example, testing process 110 may organize tests into directories and use markers to group them. For instance, testing process 110 can mark some tests as “login” tests and others as “registration” tests, and testing process 110 can then run these tests selectively using the command line, specifying the markers for the tests to execute. As another example, testing process 110 may use a CI/CD tool to configure a pipeline to run test suites. The pipeline script typically has stages for building, testing, and deploying the respective application. In the testing stage, testing process 110 specifies the commands to run your test suites, ensuring that tests are automatically executed whenever changes are made to the codebase. As yet another example, testing process 110 may create workflows to automate the testing process. For example, testing process 110 may define a workflow file that specifies triggers (such as code pushes or pull requests) and the steps to set up the environment, build the application, and run the tests. This ensures that tests are run automatically on every change, maintaining code quality. These example configurations of testing process 110 help automate the process of running tests, providing rapid feedback and ensuring that the codebase remains stable and reliable throughout the development lifecycle.

In some implementations, testing process 110 may configure 302 a first computer-based test among the plurality of computer-based tests from the computer platform for execution with a first application. For instance, in some implementations, the first application may be a web application. A web application may generally be described as a software application that runs on a web server and can be accessed through a web browser over the internet or an intranet. Web applications are typically designed to be interactive, providing users with the ability to perform tasks, access services, and retrieve information online. In some implementations, configuring the first computer-based test among the plurality of computer-based tests for execution with the first application may include adding 312 a plurality of dependencies for the first computer-based test, creating 314 a plurality of test classes for the first computer-based test, and validating 316 the first computer-based test based upon, at least in part, the plurality of dependencies and the plurality of test classes. The following example for web application automation testing involves quote generation; however, it will be appreciated after reading the present disclosure that any use cases for the web application may be used for testing without departing from the scope of the present disclosure. As such, any particular use case should be taken as example only and not to otherwise limit the scope of the present disclosure.

Assume for example purposes only that an application is used to create quotes, and the information is tracked in a datastore (e.g., database). In the example, testing process 110 may communicate between multiple other software applications (e.g., an application that new loans are booked on, a message broker software that implements the Advanced Message Queuing Protocol (AMQP) allowing applications to communicate with each other and exchange information asynchronously, payment collection process application, Automated Insurance Finance System (AIFS), a quote management application, etc. during the quote acceptance process. This may involve things like portals, agency bills, insurance links, checkout APIs, dashboards, etc., which are validated on the UI level.

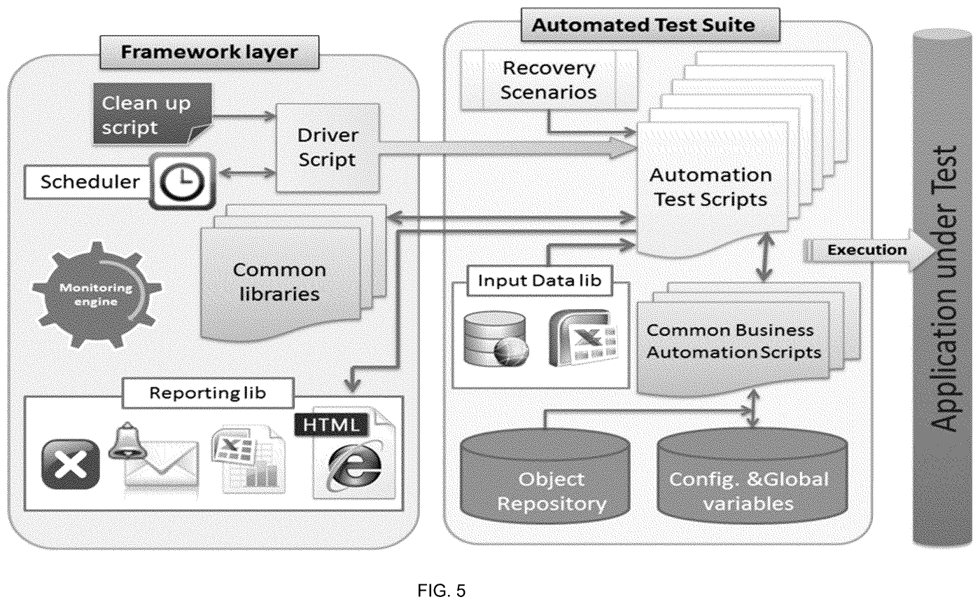

Thus, testing process 110 may make use of a WebDriver, which is a framework for automating web browsers, allowing interaction with web elements (e.g., clicking, filling forms, navigating pages, etc.) through browser specific drivers (e.g., Chrome Driver, Gecko Driver, etc.). Referring at least to the example implementation of FIG. 5, an example testing architecture 500 of testing process 110 is shown.

The framework layer of testing architecture 500 includes multiple components. For instance, the framework layer of testing architecture 500 is shown to include a Clean Up Script, a script driver, a monitoring engine, a common library, and a reporting library. A clean up script may be described as a script designed to perform maintenance tasks to ensure that a system or environment remains clean, organized, and free of unnecessary files or data. This can include, e.g., deleting temporary files-removing temporary or cache files that are no longer needed; database maintenance-removing old or obsolete entries from a database, log management-archiving or deleting old log files to free up disk space, resource release-ensuring that resources like memory or file handles are properly released; environment reset-returning a system to a baseline state after tests or deployments.

The script driver may be generally described as a script or program that controls the execution of other scripts or programs. It often coordinates various tasks and ensures they run in the correct sequence. Some functions may include, e.g., task scheduling—running scripts at specified times or in a specified order; dependency management—ensuring that tasks run only when their dependencies are satisfied; logging—keeping logs of the execution status and any errors that occur; error handling-managing errors and exceptions during script execution, etc.

The monitoring engine may be described as a system or component that continuously checks the status and performance of various elements within a system or network. It typically includes, e.g., data collection-gathering data from various sources like servers, applications, and network devices; alerting-sending notifications when specific conditions or thresholds are met (e.g., high CPU usage, low disk space); dashboards-providing visual interfaces to monitor system health in real-time; reporting-generating reports on system performance and issues over time; automated responses-taking predefined actions in response to specific events or conditions, etc.

The common library is a set of reusable code that provides common functionality across multiple applications or components. It may include utility functions-commonly used functions for tasks like string manipulation, file handling, and data conversion; data structures-implementations of data structures like lists, maps, and queues; API wrappers-simplified interfaces for interacting with external APIs or services; configurations-centralized configuration management to ensure consistency across applications; error handling-standardized mechanisms for managing errors and exceptions, etc.

A reporting library is a collection of tools and components designed to facilitate the creation, customization, and generation of reports. Features typically include, e.g., data aggregation—collecting and organizing data from various sources; report templates—predefined templates for different types of reports (e.g., sales reports, performance reports); customization—allowing users to customize the layout, style, and content of reports; export options—providing options to export reports in various formats like PDF, Excel, or HTML; visualization tools—tools to create charts, graphs, and other visual elements to represent data clearly and effectively; automated report generation—scheduling and automatically generating reports at specified intervals, etc.

In the example, testing process 110 may create a project and add the necessary dependencies, e.g., in a pom.xml file. In some implementations, testing process 110 may create test classes by defining test classes using certain annotations to set up test configurations and write test methods. The test methods may be written by testing process 110 to perform actions on web elements using the WebDriver and validate the application's behavior. The tests may be run either individually, by class, or in specified groups, where a test report will be generated to document the test results, including UI actions and validation outcomes. For example, using the WebDriver of testing process 110, various actions on web elements are tested to validate the behavior of a web application. These actions simulate user interactions with the web page and help ensure that the application works as expected. Common non-limiting actions may include clicking elements such as buttons, links, checkboxes, and radio buttons, which can be tested by verifying that these interactions submit forms, navigate to new pages, or trigger specific events like opening a modal. Entering text into input fields like text boxes and text areas is another action that can be tested. Tests involve verifying that entering valid or invalid text displays appropriate validation messages, updates the model, or allows form submission. Selecting options from dropdown menus or multi-select lists is also common, and tests ensure that selecting an option updates the application state, displays correct dependent information, or triggers events. Hovering over elements to display tooltips, highlight items, or expand dropdown menus is another interactive action that needs verification. Other actions may include double-clicking elements to trigger specific actions like opening an editor, right-clicking to open context menus and verifying their options, and dragging and dropping elements to reorder lists or move items, ensuring these actions change the application state as expected. Scrolling up, down, or to specific elements can reveal hidden content or trigger lazy loading, and tests ensure the application maintains the correct position after interactions. Submitting forms by clicking submit buttons or pressing “Enter” involves verifying that form submissions perform the correct actions, such as saving data, showing success or error messages, or redirecting to another page. Handling browser alerts, confirmation dialogs, and popups involves verifying that alerts show the correct messages, and actions like clicking OK or Cancel perform as expected, while popups appear and disappear correctly. Verifying the presence and attributes of elements is important. This includes checking if elements are present, visible, enabled, or have specific attributes, ensuring that elements exist on the page, are displayed or hidden as expected, are enabled or disabled appropriately, and have the correct text, CSS classes, or attributes.

Example test scenarios include logging in with valid and invalid credentials to verify redirection to the dashboard or the display of error messages, adding and removing items from a shopping cart to check updates and totals, filling out and submitting a registration form with valid and invalid data to verify success or validation messages, and performing a product search to ensure results are displayed and product detail pages are accessible.

To achieve these tests, the tools and libraries for automation of testing architecture 500 for structuring and running tests, running tests written in plain language, and automating mobile web applications may be used. These actions and validations ensure that the web application functions correctly and provides a good user experience.

The benefits of the above UI automation may include, e.g., speed, efficiency, repeatability, and consistency; increased test coverage and early defect detection, cross browser and cross platform compatibility; data driven testing with multiple user inputs; and integration with CI/CD pipelines.

In some implementations, the automated test suite portion of testing architecture 500 may include recovery scenarios, automation test scripts, input data library, common business automation scripts, object repository, and configuration and global variables repository, etc. Recovery scenarios are predefined sets of actions or steps that an automated test should take when encountering unexpected events or errors during execution. These scenarios help ensure that tests can recover gracefully from interruptions or failures and continue running. Examples include restarting a browser if it crashes during a test, logging an error and moving to the next test case if a particular test fails, and handling unexpected pop-ups or dialogs.

Automation test scripts are the actual scripts or code written to perform automated testing. These scripts simulate user interactions with the application under test, verify expected outcomes, and report results. The input data library is a collection of data sets used by these scripts, containing the input values, parameters, and test data required to execute test cases. This library enables data-driven testing, allowing the same test script to be executed multiple times with different data sets, thus validating the application's behavior under various conditions and scenarios.

Common business automation scripts are reusable scripts that encapsulate business logic or common functionalities used across multiple test cases. These scripts help maintain consistency and reduce redundancy by providing a single source of truth for frequently performed actions, such as user login, navigation through the application, and form submission. The object repository is a centralized storage location for all web elements and objects used in the automation test scripts. It contains the definitions and properties of these objects, like element locators (e.g., IDs, names, XPaths), making it easier to update locators when the application's UI changes without modifying the test scripts.

The configuration and global variables repository store configuration settings and global variables used by the automation framework. This repository includes environment-specific settings (e.g., URLs, database connections), credentials, authentication details, and global constants and parameters used across multiple test scripts. Storing this information in a centralized repository may help ensure consistency and simplifies management and updates across the test suite.

These components work together to create a comprehensive and maintainable automated testing framework within a single platform. Automation test scripts utilize the object repository to interact with web elements and fetch test data from the input data library. They call common business automation scripts for frequently performed actions and implement recovery scenarios to handle unexpected events and errors. Data-driven testing is achieved by parameterizing test scripts to accept input from the input data library, allowing the same script to validate various scenarios. Configuration management is streamlined by using the configuration and global variables repository, which manages environment-specific settings and updates without modifying the test scripts. Implementing recovery scenarios ensures that tests can continue running or provide meaningful error reports when failures occur, contributing to a reliable and efficient testing process.

In some implementations, testing process 110 may configure 304 a second computer-based test among the plurality of computer-based tests from the computer platform for execution with a second application. For instance, in some implementations, the second application may be an application programming interface (API) application. As will be discussed below, in some implementations, configuring the second computer-based test among the plurality of computer-based tests for execution with the second application may include adding 318 a plurality of dependencies for the second computer-based test, generating 320 API test cases for the second computer-based test, serializing 322 data associated with the API test cases, deserializing 324 the data associated with the API test cases, and validating 326 the second computer-based test based upon, at least in part, the API test cases.

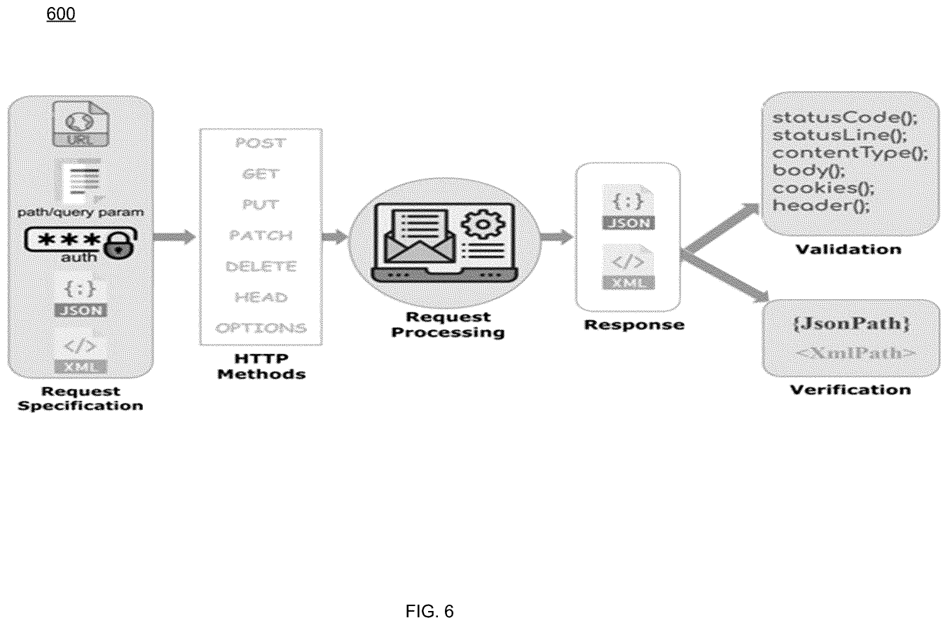

For example, there may be 100+ active microservices involved during the End-to-End flow, which need to executed whenever there is any change in application or major deployment. PFA generation is a valuable process of testing process 110 and generated at multiple levels for different states. Testing will be a time-consuming activity when there is a small change requirement. For this particular automation approach of testing process 110, testing process 110 may be implemented alongside the high-level object-oriented programming language and libraries like RestAssured or Apache HTTP Client used for API test automation. For instance, and referring at least to the example implementation of FIG. 6, an example, API test automation process 600 of testing process 110 is shown. In the example, there is shown the request specification, the HTTP methods, the request processing, the response, and the validation.

The request specification may be used to set up dependencies (e.g., Rest Assured pr Apache HTTP Client dependencies in project setup). The HTTP methods may be used for writing API test cases (e.g., testing process 110 may use Java to send HTTP requests (e.g., GET, POST, PUT, DELETE, etc.) to API endpoints and the request processing, responses, and validations may be used to verify the responses (e.g., Status Codes, response body) using assertion libraries).

Serialization/Deserialization may use objects like Java's “Jackson” or “Gson” libraries for JSON serialization and deserialization when working with JSON data. For example, serialization and deserialization may refer to the processes of converting an object into a byte stream and reconstructing the object from that byte stream, respectively. Serialization allows an object to be converted into a format that can be easily stored in a file, sent over a network, or saved in a database. This is useful for persistent storage, network communication, and caching. To enable serialization, a class implements the serializable interface of testing process 110, which serves as a marker indicating that the class can be serialized. During serialization, the state of an object is saved, enabling it to be retrieved and used later. Deserialization is the reverse process, where the byte stream is used to reconstruct the original object, restoring it to its previous state. This process requires the same class used for serialization to be available during deserialization. In practice, serialization involves writing the object's state to a byte stream, while deserialization involves reading this byte stream to recreate the object. Fields marked with the transient keyword are not serialized, which is useful for sensitive information or non-serializable dependencies. Custom serialization can be achieved by implementing specific methods in the class. The authentication may handle authentications mechanisms (e.g., basic. auth, OAuth, Tokens).

Advantageously, automated API tests executed in this fashion may be defined within collections to verify API behavior and ensure compliance with expected results, and the collections feature is beneficial for managing multiple endpoints and environments, and is easily integrated with CI/CD pipelines using a single platform.

In some implementations, testing process 110 may configure 306 a third computer-based test among the plurality of computer-based tests from the computer platform for execution with a third application. For instance, in some implementations, the third application may be a datastore application, where, in some implementations, configuring the third computer-based test among the plurality of computer-based tests for execution with the third application may include initializing 328 a webdriver for browser automation, performing 330 simulated user interface (UI) actions on the web application, and validating 332 UI data for the third computer-based test by comparing the UI data with results from the datastore application.

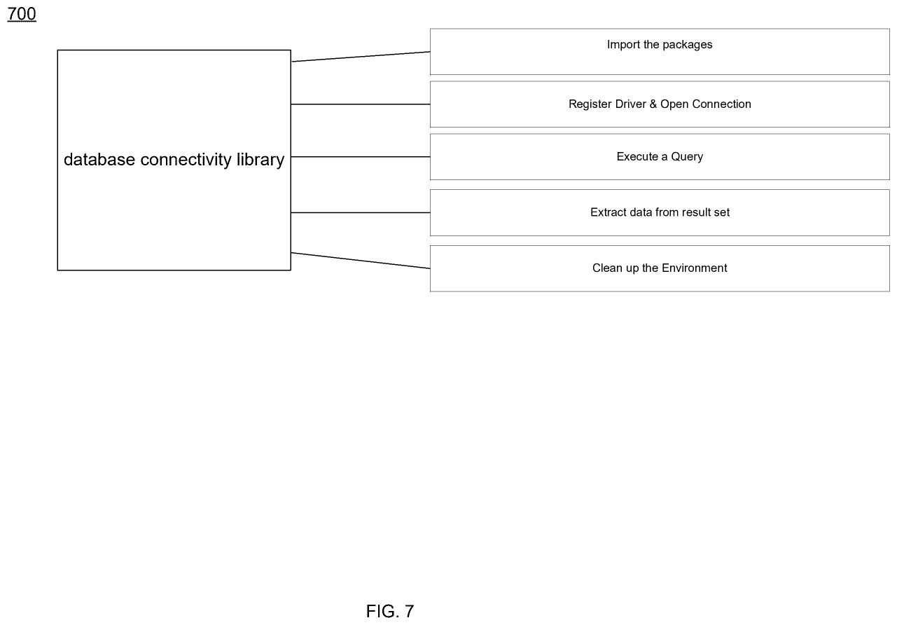

For instance, certain transactions (e.g., QIV, Contrac, PMP, AIFS transactions) may be stored in database at multiple levels. For the automation approach of testing process 110 for datastore applications, testing process 110 may include an automation framework that provide the capability to connect to the database (e.g., via a WebDriver to automate web application interactions, as well as the database connectivity library to facilitate database connectivity and query execution). For example, and referring at least to the example implementation of FIG. 7, an example workflow 700 of a high-level object-oriented programming language of testing process 110 is shown. In the example, testing process 110 may import the packages, register drivers and open connections, execute queries, extract data from the result set, and clean up the environment.

For instance, testing process 110 may import the packages by including the necessary libraries, which provides the classes and interfaces for the database connectivity (DBC) API. Registering the driver ensures that the DBC driver for the specific database is loaded into memory, using the Class.forName method as one example. Once the driver is registered, a connection to the database may be established using the example DriverManager.getConnection method, which may use the database URL, username, and password, returning a connection object that represents this connection.

Executing the involves queries creating, e.g., Statement, PreparedStatement, or CallableStatement objects using the connection object to send SQL commands to the database. These commands can be, e.g., SELECT, INSERT, UPDATE, or DELETE statements to simulate user actions like logging in and data entry. For SELECT statements, the execution may returns a ResultSet object. Following query execution, extracting the data from the result set may involve the ResultSet object, which contains the data retrieved from the database, and this can be iterated over it using methods like next, which moves the cursor to the next row. Data from each column can be extracted using methods such as getString, getInt, and getDouble, depending on the column data type. The data may be validated by comparing captured data displayed on the UI after action with database results to ensure consistency. Finally, testing process 110 may clean up the environment by closing all database resources once they are no longer needed. This involves closing the ResultSet, Statement, and Connection objects, typically done in a finally block to ensure they are closed even if an exception occurs. Proper cleanup prevents resource leaks, which can lead to performance issues and limit the number of available connections.

Advantageously, testing process 110 may thus be able to use the same platform for database automation, leading to the automation of script setup test data and configurations, predefined automation scripts to execute tests query databases, validate the results, and generate report automatically. This automation approach using one platform runs tests faster and covers more scenarios in less time than manual intervention, which can be repeatedly run with consistent results, and it is easily integrate with the CI/CD pipelines for continuous testing.

In some implementations, testing process 110 may configure 308 a fourth computer-based test among the plurality of computer-based tests from the computer platform for execution with a fourth application. For instance, in some implementations, the fourth application may be a mainframe application. For example, in some implementations, configuring the fourth computer-based test among the plurality of computer-based tests for execution with the fourth application may include configuring 334 a terminal emulator to be executed with the fourth-computer-based test, and executing 336 one or more scripts to navigate through mainframe screens, input data, and verify outputs.

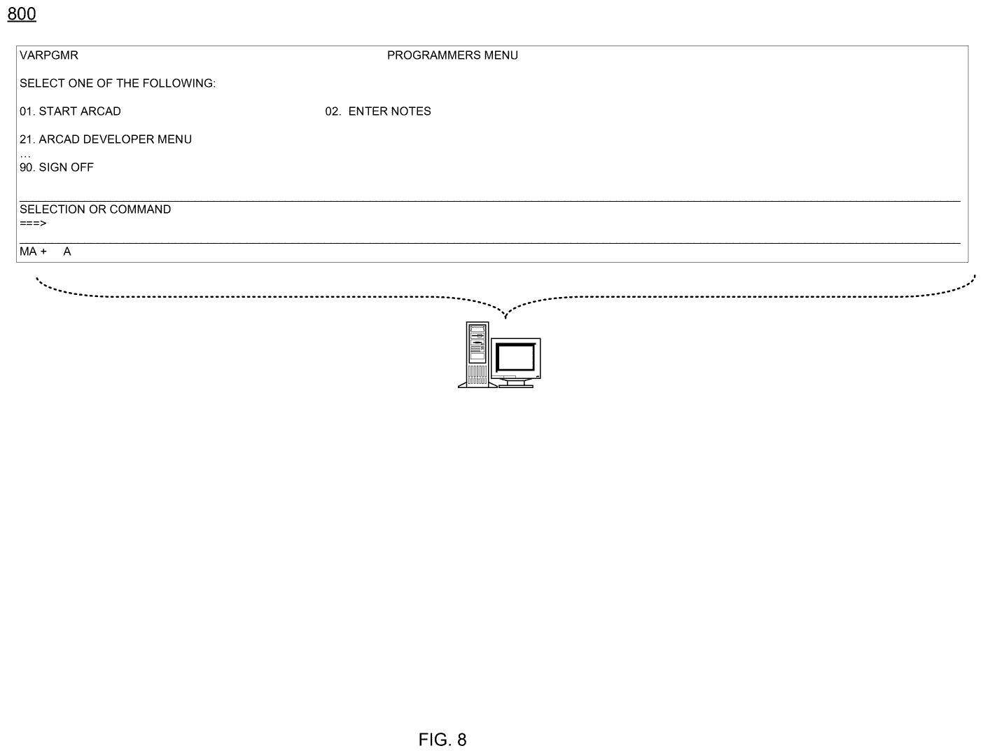

For instance, for using testing process 110 to also include mainframe automation, some mainframe applications (e.g., AIFS) may reside on a partition. AIFS (used as an example only) is a downstream system to other systems (e.g., QIV, Contrac, PMP, MyAFCO) and acts as an upstream system for the AIV application. PFA generation from AIFS for multiple states will be frequent activity, and testing will be a time consuming activity when there is a small change requirement. Typically, this is done by logging into the AIFS server, as shown in the example displayed screen 800 of FIG. 8

Typically, the user must enter option 7 to enter into the AIFS application, and some frequently accessed screens are screen 36—Account search, Screen 37—Policy search, Screen 38—Account History, Screen 46—ACH instructions to print Loan acceptance letters, PFAs, etc., Screen 64—Disbursement details, Screen 31—Manual account booking (e.g., Direct Bill, Standard Financed accounts), etc.

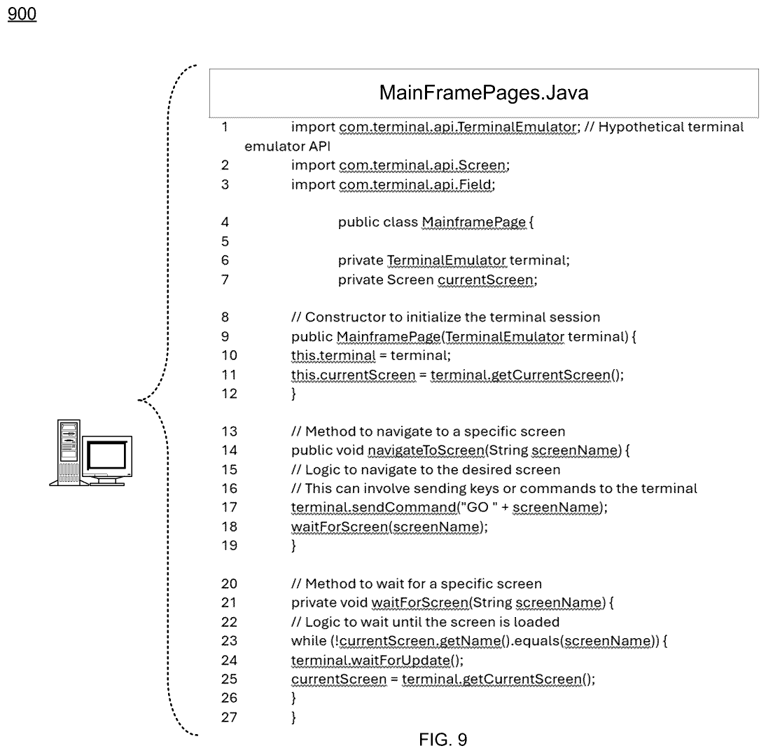

Using testing process 110 as the automation framework provides the capability to connect to the mainframe through a mainframe emulator of testing process 110 and perform the necessary actions and validations. This may be done by downloading the mainframe emulator executable on the computer executing testing process 110. Referring at least to the example implementation of FIG. 9, an example mainframe page class 900 for automating a hypothetical mainframe application is shown.

Although not shown, mainframe page class 900 may include mainframe.showTerminal, which is a property used to determine if the Terminal Emulator should be displayed when the test being executed. If this is set to false, the terminal emulator window would not be shown when test execution is occurring. Mainframe page class 900 may also include mainframe.host (not shown), which is a property used to define the Host to connect to through the terminal emulator. Mainframe page class 900 may also include mainframe.port (not shown), which is a property used to define the port over which the mainframe session is to be created. The scripting is used by testing process 110 to develop scripts to navigate mainframe screens, input data, and verify outputs.

In some implementations, testing process 110 may include a terminal emulator. A terminal emulator may be described as a software application designed to replicate the functionalities of a traditional computer terminal, enabling users to access and interact with the command-line interface (CLI) of another computer system, such as a mainframe or server, over a network. Terminal emulators enable connecting to remote systems, particularly in environments where graphical user interfaces (GUIs) are not available or practical. They allow users to type and execute commands as if they were working directly on the remote system's console, providing a text-based interface that supports various command-line applications and utilities.

Through protocols like SSH (Secure Shell), Telnet, or serial connections, the terminal emulator facilitates remote access to servers, mainframes, and network devices, and may support scripting and automation capabilities of testing process 110, enabling repetitive tasks to be automated through scripts, and some include features for transferring files between local and remote systems using protocols like SCP (Secure Copy Protocol) or SFTP (SSH File Transfer Protocol). Additionally, the terminal emulator of testing process 110 may offer customization options for appearance, keyboard shortcuts, and behavior, as well as the ability to save connection profiles for different remote systems.

In some implementations, the terminal emulator of testing process 110 can be altered to support specific protocols and interfaces used to communicate with particular mainframes, handling the unique screen and field formats of these applications. The terminal emulator thus provides a bridge between local and remote computing environments, facilitating efficient system administration, development, and network management.

In some implementations, testing process 110 may execute 310 each of the first computer-based test, the second computer-based test, the third computer-based test, and the fourth computer-based test from the computer platform. Thus, advantageously, using testing process 110 for mainframe automation enhances testing efficiency, accelerates release cycles, and improves accuracy in detecting issues within critical mainframe applications. As a result, unlike current systems, testing process 110 enables predefined automation scripts to be used to execute End-to End testing solutions to the UI application, API application, mainframe application, and query database application to validate the results, and generate report automatically, without requiring multiple computer platforms for each individual application to be tested.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, comprising:
generating, by a computing device, a plurality of computer-based tests to be executed from a computer platform;
configuring, from the computer platform by the computing device, a first computer-based test among the plurality of computer-based tests for execution with a first software application;
configuring, from the computer platform by the computing device, a second computer-based test among the plurality of computer-based tests for execution with a second software application;
configuring, from the computer platform by the computing device, a third computer-based test among the plurality of computer-based tests for execution with a third software application;
configuring, from the computer platform by the computing device, a fourth computer-based test among the plurality of computer-based tests for execution with a fourth software application; and
executing, by the computing device, each of the first computer-based test, the second computer-based test, the third computer-based test, and the fourth computer-based test from the computer platform.

2. The computer-implemented method of claim 1, wherein:
the first software application is a web-based software application,
the second application is an application programming interface (API) application, and
the third application is a datastore application.

3. The computer-implemented method of claim 2, wherein configuring the first computer-based test among the plurality of computer-based tests for execution with the first application includes:
adding a plurality of dependencies for the first computer-based test;
creating a plurality of test classes for the first computer-based test; and
validating the first computer-based test based upon, at least in part, the plurality of dependencies and the plurality of test classes.

4. The computer-implemented method of claim 2, wherein configuring the second computer-based test among the plurality of computer-based tests for execution with the second application includes:
adding a plurality of dependencies for the second computer-based test;
generating API test cases for the second computer-based test;
serializing data associated with the API test cases;
deserializing the data associated with the API test cases; and
validating the second computer-based test based upon, at least in part, the API test cases.

5. The computer-implemented method of claim 2, wherein configuring the third computer-based test among the plurality of computer-based tests for execution with the third application includes:
initializing a webdriver for browser automation;
performing simulated user interface (UI) actions on the web application; and
validating UI data for the third computer-based test by comparing the UI data with results from the datastore application.

6. The computer-implemented method of claim 2, wherein the fourth application is a mainframe application.

7. The computer-implemented method of claim 6, wherein configuring the fourth computer-based test among the plurality of computer-based tests for execution with the fourth application includes:
configuring a terminal emulator to be executed with the fourth-computer-based test; and
executing one or more scripts to navigate through mainframe screens, input data, and verify outputs.

8. A computer program product residing on a computer readable storage medium having a plurality of instructions stored thereon which, when executed across one or more processors, causes at least a portion of the one or more processors to perform operations comprising:
configuring, from the computer platform, a first computer-based test among the plurality of computer-based tests for execution with a first software application;
configuring, from the computer platform, a second computer-based test among the plurality of computer-based tests for execution with a second software application;
configuring, from the computer platform, a third computer-based test among the plurality of computer-based tests for execution with a third software application;
configuring, from the computer platform, a fourth computer-based test among the plurality of computer-based tests for execution with a fourth software application; and
executing each of the first computer-based test, the second computer-based test, the third computer-based test, and the fourth computer-based test from the computer platform.

9. The computer program product of claim 8, wherein:
the first software application is a web-based software application,
the second application is an application programming interface (API) application, and
the third application is a datastore application.

10. The computer program product of claim 9, wherein configuring the first computer-based test among the plurality of computer-based tests for execution with the first application includes:
adding a plurality of dependencies for the first computer-based test;
creating a plurality of test classes for the first computer-based test; and
validating the first computer-based test based upon, at least in part, the plurality of dependencies and the plurality of test classes.

11. The computer program product of claim 9, wherein configuring the second computer-based test among the plurality of computer-based tests for execution with the second application includes:
adding a plurality of dependencies for the second computer-based test;
generating API test cases for the second computer-based test;
serializing data associated with the API test cases;
deserializing the data associated with the API test cases; and
validating the second computer-based test based upon, at least in part, the API test cases.

12. The computer program product of claim 9, wherein configuring the third computer-based test among the plurality of computer-based tests for execution with the third application includes:
initializing a webdriver for browser automation;
performing simulated user interface (UI) actions on the web application; and
validating UI data for the third computer-based test by comparing the UI data with results from the datastore application.

13. The computer program product of claim 9, wherein the fourth application is a mainframe application.

14. The computer program product of claim 13, wherein configuring the fourth computer-based test among the plurality of computer-based tests for execution with the fourth application includes:
configuring a terminal emulator to be executed with the fourth-computer-based test; and
executing one or more scripts to navigate through mainframe screens, input data, and verify outputs.

15. A computing system including one or more processors and one or more memories configured to perform operations comprising:
configuring, from the computer platform, a first computer-based test among the plurality of computer-based tests for execution with a first software application;
configuring, from the computer platform, a second computer-based test among the plurality of computer-based tests for execution with a second software application;
configuring, from the computer platform, a third computer-based test among the plurality of computer-based tests for execution with a third software application;
configuring, from the computer platform, a fourth computer-based test among the plurality of computer-based tests for execution with a fourth software application; and
executing each of the first computer-based test, the second computer-based test, the third computer-based test, and the fourth computer-based test from the computer platform.

16. The computing system of claim 15, wherein:
the first software application is a web-based software application,
the second application is an application programming interface (API) application,
the third application is a datastore application, and
the fourth application is a mainframe application.

17. The computing system of claim 16, wherein configuring the first computer-based test among the plurality of computer-based tests for execution with the first application includes:
adding a plurality of dependencies for the first computer-based test;
creating a plurality of test classes for the first computer-based test; and
validating the first computer-based test based upon, at least in part, the plurality of dependencies and the plurality of test classes.

18. The computing system of claim 16, wherein configuring the second computer-based test among the plurality of computer-based tests for execution with the second application includes:
adding a plurality of dependencies for the second computer-based test;
generating API test cases for the second computer-based test;
serializing data associated with the API test cases;
deserializing the data associated with the API test cases; and
validating the second computer-based test based upon, at least in part, the API test cases.

19. The computing system of claim 16, wherein configuring the third computer-based test among the plurality of computer-based tests for execution with the third application includes:
initializing a webdriver for browser automation;
performing simulated user interface (UI) actions on the web application; and
validating UI data for the third computer-based test by comparing the UI data with results from the datastore application.

20. The computing system of claim 16, wherein configuring the fourth computer-based test among the plurality of computer-based tests for execution with the fourth application includes:
configuring a terminal emulator to be executed with the fourth-computer-based test; and
executing one or more scripts to navigate through mainframe screens, input data, and verify outputs.
